(19) United States
(12) Patent Application Publication
(10) Pub. No.: US 2013/0281764 A1
(43) Pub. Date: Oct. 24, 2013

(54) TRANSCUTANEOUS BONE CONDUCTION DEVICE

(71) Applicants: Göran Björn, Onsala (SE); Marcus Andersson, Goteborg (SE); Stefan Magnander, Goteborg (SE)

(72) Inventors: Göran Björn, Onsala (SE); Marcus Andersson, Goteborg (SE); Stefan Magnander, Goteborg (SE)

(21) Appl. No.: 13/451,171

(22) Filed: Apr. 19, 2012

(51) Int. Cl. H04R 25/00

(52) U.S. Cl. 600/25

(57) ABSTRACT

An implantable component of a hearing prosthesis, including a bone fixture and one or more magnets, wherein at least one of the one or more magnets is disposed in a housing coupled to the bone fixture via a structure that extends from the housing to the bone fixture.

### BACKGROUND

The present disclosure relates generally to bone conduction devices, and more particularly, to transcutaneous bone conduction devices.

Hearing loss, which may be due to many different causes, is generally of two types: conductive and sensorineural. Sensorineural hearing loss is due to the absence or destruction of the hair cells in the cochlea which transduce sound signals into nerve impulses. Various hearing prostheses are commercially available to provide individuals suffering from sensorineural hearing loss with the ability to perceive sound. For example, cochlear implants include an electrode array for implantation in the cochlea to deliver electrical stimuli to the auditory nerve, thereby causing a hearing percept.

Conductive hearing loss occurs when the normal mechanical pathways that provide sound to hair cells in the cochlea are impeded, for example, by damage to the ossicular chain or ear canal. Individuals suffering from conductive hearing loss may retain some form of residual hearing because the hair cells in the cochlea may remain undamaged.

Individuals suffering from conductive hearing loss typically receive an acoustic hearing aid. Hearing aids rely on principles of air conduction to transmit acoustic signals to the cochlea. In particular, a hearing aid typically uses a component positioned at the recipient's auricle or ear canal which amplifies received sound. This amplified sound reaches the cochlea causing stimulation of the auditory nerve.

In contrast to hearing aids, certain types of hearing prostheses commonly referred to as bone conduction devices, convert a received sound into mechanical vibrations. The vibrations are transferred through the skull or jawbone to the cochlea causing generation of nerve impulses, which result in the perception of the received sound. Bone conduction devices may be a suitable alternative for individuals who cannot derive sufficient benefit from acoustic hearing aids, cochlear implants, etc.

### SUMMARY

In accordance with one aspect of the present disclosure, there is an implantable component of a prosthesis, comprising a bone fixture and one or more magnets disposed in a housing coupled to the bone fixture via a structure that extends from the housing to the bone fixture.

In accordance with another aspect of the present disclosure, there is an implantable component of a prosthesis, comprising a bone fixture and at least one magnet coupled to the bone fixture and offset from the bone fixture and all outer peripheries of the magnet extend within an area bounded by legs of an angle about a longitudinal axis of the bone fixture that is less than 360 degrees and all outer peripheries of the magnet extend within an area outside a footprint of the bone fixture on a plane normal to the longitudinal axis of the bone fixture.

In accordance with another aspect of the present disclosure, there is an implantable hearing prosthesis, comprising a bone fixture and at least one magnet disposed in a housing, wherein the housing is flexibly coupled to the bone fixture.

### BRIEF DESCRIPTION OF THE DRAWINGS

Embodiments of the present disclosure are described below with reference to the attached drawings, in which:

FIG. 1 is a perspective view of an exemplary bone conduction device in which embodiments of the present disclosure may be implemented;

FIGS. 2A and 2B are cross-sectional diagrams of exemplary bone fixtures with which embodiments of the present disclosure may be implemented;

FIG. 3 is a schematic diagram illustrating an exemplary passive transcutaneous bone conduction device in which embodiments of the present disclosure may be implemented;

FIG. 4A is a schematic diagram illustrating additional details of the implantable magnetic assembly of FIG. 3;

FIG. 4B is a schematic diagram illustrating additional details of the implantable component of FIG. 3;

FIG. 5 is a schematic diagram illustrating an embodiment of an implantable component of a passive bone conduction device;

FIG. 6 is a perspective view of an embodiment of an implantable magnetic assembly of a passive bone conduction device;

FIG. 7 is a schematic diagram illustrating an embodiment of an implantable component of a passive bone conduction device;

FIG. 8 is a schematic diagram illustrating an embodiment of an implantable component of a passive bone conduction device;

FIG. 9A is a schematic diagram illustrating an embodiment of an implantable component of a passive bone conduction device; and

FIG. 9B is a cross-sectional view of the embodiment of FIG. 9A.

### DETAILED DESCRIPTION

Aspects of the present disclosure are generally directed to a transcutaneous bone conduction device configured to deliver mechanical vibrations generated by an external vibrator to a recipient's cochlea via the skull to cause a hearing percept. The bone conduction device includes an implantable bone fixture adapted to be secured to the skull, and one or more magnets disposed in a housing coupled to the bone fixture via a structure that extends from the housing to the bone fixture. When implanted, the one or more magnets are capable of forming a magnetic coupling with the external vibrator sufficient to permit effective transfer of the mechanical vibrations to the implanted magnets, which are then transferred to the skull via the bone fixture.

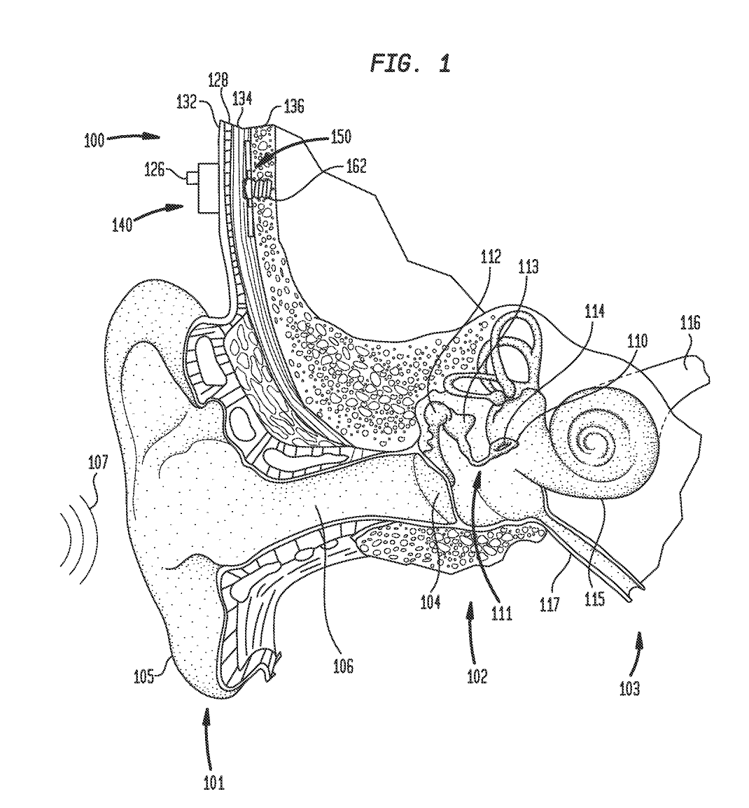

FIG. 1 is a perspective view of a transcutaneous bone conduction device 100 in which embodiments of the present disclosure may be implemented. As shown, the recipient has an outer ear 101, a middle ear 102 and an inner ear 103. In a fully functional human hearing anatomy, outer ear 101 comprises an auricle 105 and an ear canal 106. Sound waves 107 is collected by auricle 105 and channeled into ear canal 106. Disposed across the distal end of ear canal 106 is a tympanic membrane 104 which vibrates in response to acoustic wave 107. This vibration is coupled to oval window or fenestra ovalis 110 through three bones of middle ear 102, collectively referred to as the ossicles 111 and comprising the malleus 112, the incus 113 and the stapes 114. Ossicles 111 serve to filter and amplify acoustic wave 107, causing oval window 110 to vibrate. Such vibration sets up waves of fluid motion within cochlea 139 which, in turn, activates hair cells lining the inside of the cochlea. Activation of the hair cells causes appropriate nerve impulses to be transferred through the spiral ganglion cells and auditory nerve 116 to the brain, where they are perceived as sound.

FIG. 1 also illustrates the positioning of bone conduction device 100 on the recipient. As shown, bone conduction device 100 is secured to the skull behind outer ear 101. Bone conduction device 100 comprises an external component 140 that includes a sound input element 126 to receive sound signals. Sound input element 126 may comprise, for example, a microphone, telecoil, etc. In an exemplary embodiment, sound input element 126 may be located, for example, on or in bone conduction device 100, on a cable or tube extending from bone conduction device 100, etc. Alternatively, sound input element 126 may be subcutaneously implanted in the recipient, or positioned in the recipient's ear. Sound input element 126 may also be a component that receives an electronic signal indicative of sound, such as, for example, from an external audio device.

External component 140 also comprises a sound processor (not shown), an actuator (also not shown) and/or various other functional components. In operation, sound input device 126 converts received sound into electrical signals. These electrical signals are processed by the sound processor to generate control signals that cause the actuator to vibrate. The actuator converts the electrical signals into mechanical vibrations for delivery to internal component 150.

Internal component 150 comprises a bone fixture 162 such as a bone screw to secure an implantable magnetic component 164 to skull 136. Typically, bone fixture 162 is configured to osseointegrate into skull 136. Magnetic component 164 forms a magnetic coupling with one or more magnets disposed in external component 140 sufficient to permit effective transfer of the mechanical vibrations to internal component 150, which are then transferred to the skull.

The exemplary transcutaneous bone conduction device illustrated in FIG. 1 has all active components, such as the actuator, located externally. As such, the device illustrated in FIG. 1 is commonly referred to as a passive transcutaneous bone conduction device.

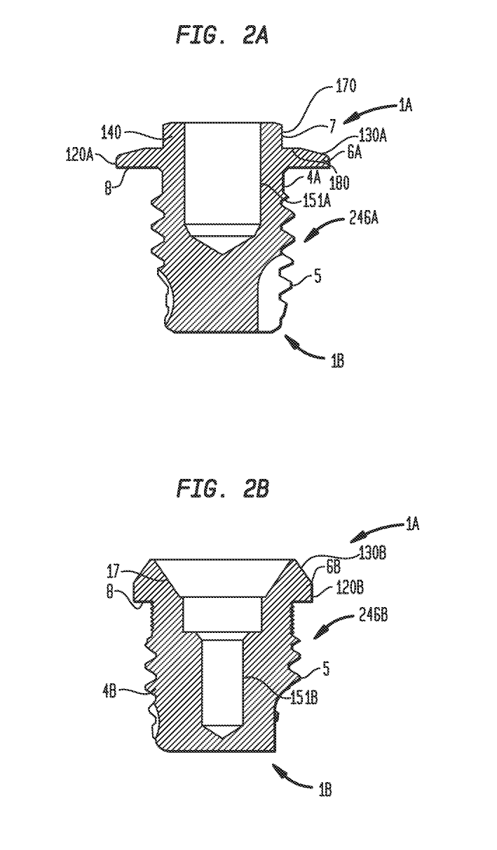

FIGS. 2A and 2B are cross-sectional views of bone fixtures 246A and 246B that may be used in exemplary embodiments of the present disclosure. Bone fixtures 246 are configured to receive an abutment, as is known in the art, where an abutment screw is used to attach the abutment to the bone fixtures, as will be detailed below.

Bone fixtures 246 may be made of any material that has a known ability to integrate into surrounding bone tissue (i.e., it is made of a material that exhibits acceptable osseointegration characteristics). In one embodiment, bone fixtures 246 are made of titanium.

As shown, each bone fixture 246 includes a main body 4A, 4B, respectively, and an outer screw thread 5 configured to be implanted into the skull. Fixtures 246A and 246B also each respectively comprise flanges 6A and 6B configured to abut the skull thereby preventing the fixtures from being inserted further into the skull. Fixtures 246 may further comprise a tool-engaging socket having an internal grip section for easy lifting and handling of the fixtures. Tool-engaging sockets and the internal grip sections usable in bone fixtures according to some embodiments of the present disclosure are described and illustrated in International Patent Publications WO2009/015102 and WO2009/015103.

Main bodies 4A and 4B have a length that is sufficient to securely anchor the bone fixtures into the skull without penetrating entirely through the skull. The length of main bodies 4A and 4B may depend, for example, on the thickness of the skull at the implantation site. In one embodiment, the main bodies of the fixtures have a length that is no greater than 5 mm, measured from the planar bottom surface 8 of the flanges 6A and 6B to the end of the distal region 1B. In another embodiment, the length of the main bodies is from about 3.0 mm to about 5.0 mm.

In the embodiment depicted in FIG. 2A, main body 4A of bone fixture 246A has a cylindrical proximate end 1A, a straight, generally cylindrical body, and a screw thread 5. The distal region 1B of bone fixture 246A may be fitted with self-tapping cutting edges formed in the exterior surface of the fixture. Further details of the self-tapping features that may be used in some embodiments of bone fixtures are described in International Patent Publication WO 2002/009622.

Additionally, as shown in FIG. 2A, the main body of the bone fixture 246A has a tapered apical proximate end 1A, a straight, generally cylindrical body, and a screw thread 5. The distal region 1B of bone fixtures 246A and 246B may also be fitted with self-tapping cutting edges (e.g., three edges) formed into the exterior surface of the fixture.

A clearance or relief surface may be provided adjacent to the self-tapping cutting edges. Such a design may reduce the squeezing effect between the fixture 246A and the bone during installation of the screw by creating more volume for the cut-off bone chips.

As illustrated in FIGS. 2A-2B, flanges 6A and 6B have a planar bottom surface for resting against the outer bone surface, when the bone fixtures have been screwed into the skull. In an exemplary embodiment, flanges 6 have a diameter which exceeds the peak diameter of screw threads 5 (screw threads 5 of bone fixtures 246 may have an outer diameter of about 3.5-5.0 mm). In one embodiment, the diameter of flanges 6 exceeds the peak diameter of screw threads 5 by approximately 10-20%. Although flanges 6 are illustrated in FIGS. 2A-2B as being circumferential, the flanges may be configured in a variety of shapes. Also, the size of flanges 6 may vary depending on the particular application for which the bone conduction implant is intended.

In FIG. 2B, the outer peripheral surface of flange 6B has a cylindrical part 120B and a flared top portion 130B. The upper end of flange 6B is designed with an open cavity having a tapered inner side wall 17. Tapered inner side wall 17 is adjacent to the grip section (not shown).

It is noted that the interiors of the fixtures 246A and 246B further respectively include an inner bottom bore 151A and 151B, respectively, having internal screw threads for securing a coupling shaft of an abutment screw to secure respective abutments to the respective bone fixtures as will be described in greater detail below.

In FIG. 2A, upper end 1A of fixture 246A is designed with a cylindrical boss 140 having a coaxial outer side wall 170 extending at a right angle from a planar surface 180A at the top of flange 6A.

In the embodiments illustrated in FIGS. 2A and 2B, flanges 6 have a smooth, open upper end and do not have a protruding hex. The smooth upper end of the flanges and the absence of any sharp corners provides for improved soft tissue adaptation. Flanges 6A and 6B also comprise a cylindrical part 120A and 120B, respectively, that together with the flared upper parts 130A and 130B, respectively, provides sufficient height in the longitudinal direction for internal connection with the respective abutments that may be attached to the bone fixtures.

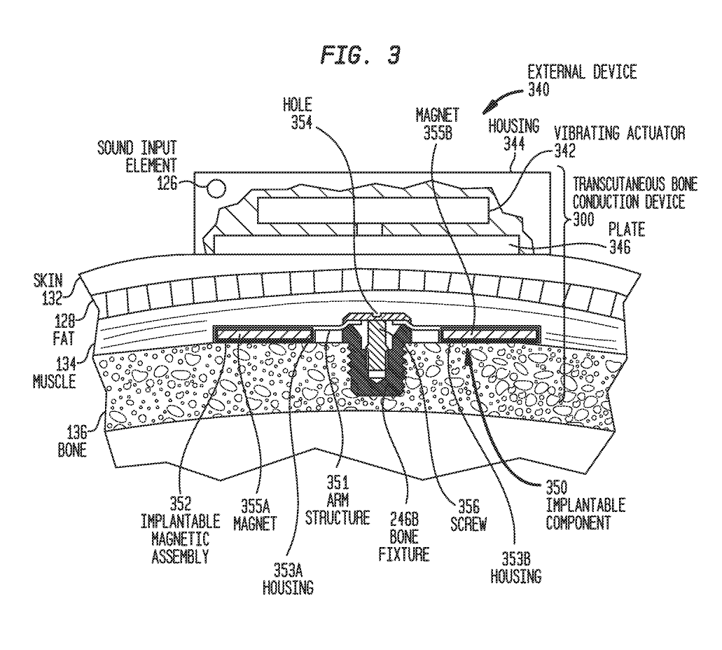

FIG. 3 depicts an exemplary embodiment of transcutaneous bone conduction device 100, referred to herein as transcutaneous bone conduction device 300. Device 300 includes an external device 340 and an implantable component 350. Device 300 is a passive transcutaneous bone conduction device because a vibrating actuator 342 is located in external device 340. Vibrating actuator 342 is located in housing 344 and is coupled to plate 346. Plate 346 may be in the form of a permanent magnet and/or in another form that generates and/or is reactive to a magnetic field, or otherwise permits the establishment of magnetic attraction between the external device 340 and the implantable component 350 sufficient to hold the external device 340 against the skin of the recipient.

In an exemplary embodiment, vibrating actuator 342 converts electrical signals into vibrations. In operation, sound input element 126 converts ambient sound into electrical signals which are provided to a sound processor (not shown). The sound processor processes the electrical signals to generate control signals which are provided to vibrating actuator 342. Vibrating actuator 342 generates vibrations in response to the control signals. Because vibrating actuator 342 is mechanically coupled to plate 346, the vibrations are transferred from the actuator to the plate. Implantable magnetic assembly 352 includes two separate permanent magnets 355A and 355B hermetically sealed in two separate housings 353A and 353B, respectively. It is noted that in other embodiments, elements 355A and 355B may alternatively or additionally be ferromagnetic material that is reactive to a magnetic field, or otherwise permits the establishment of a magnetic attraction between external device 340 and implantable component 350 sufficient to hold the external device against the recipient's skin. Accordingly, vibrations produced by vibrating actuator 342 are transferred from plate 346 across the skin to implantable component 350. This may be accomplished as a result of mechanical conduction of the vibrations through the skin, resulting from external device 340 being in direct contact with the skin and/or from the magnetic field between the two plates. These vibrations are transferred without penetrating the skin with an object such as an abutment.

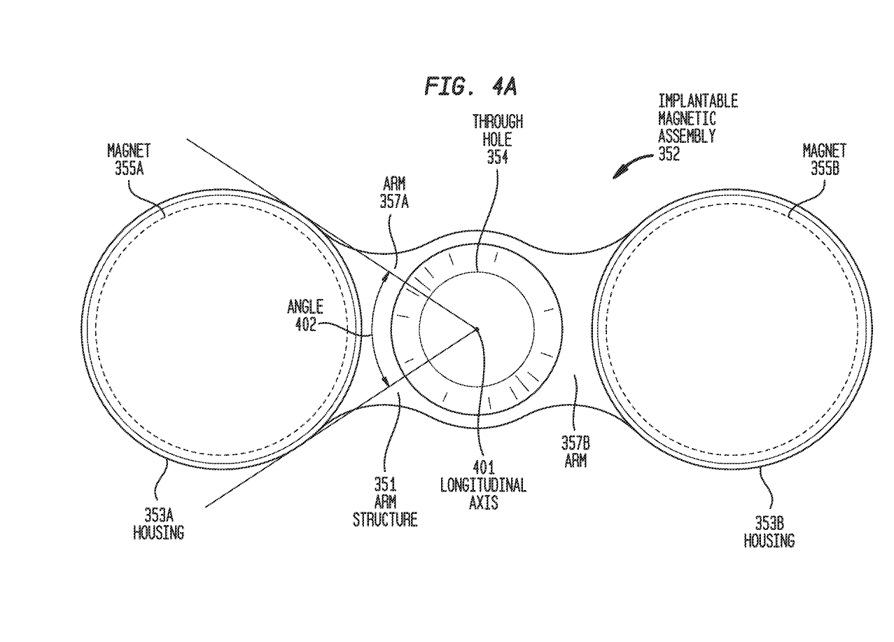

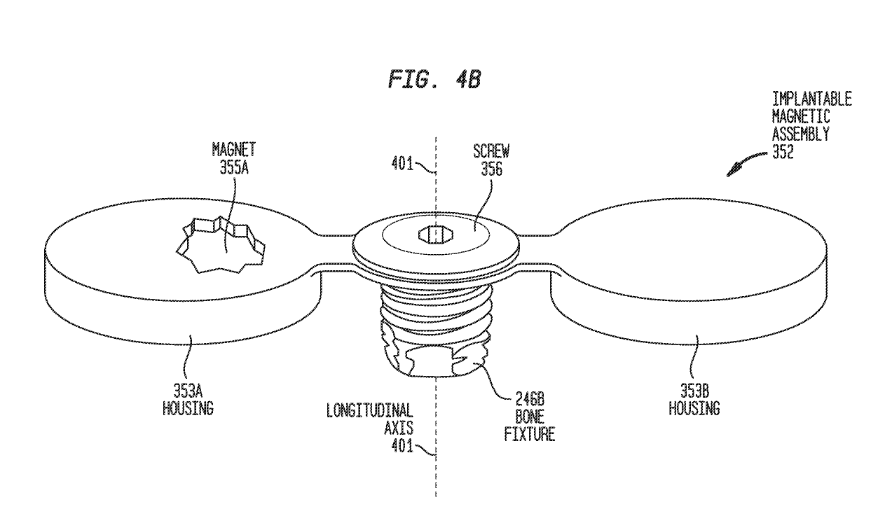

FIG. 4A is a top view and FIG. 4B is an isometric view of an embodiment of implantable magnetic assembly 352. As may be seen, implantable magnetic assembly 352 is attached to bone fixture 246B. As noted, in alternative embodiments, bone fixture 246A or other bone fixture may be used in place of bone fixture 246B. Arms 357A and 357B extend respectively from housings 353A and 353B to bone fixture 246B. In the illustrative embodiment, arms 357A and 357B are structures that are part of a monolithic arm structure 351 that holds the two housings 353A and 353B (and thus the magnets contained therein) at fixed spatial orientation relative to one another in the absence of flexing or other deformation of the monolithic structure. As may be seen, arm structure 351 includes a through hole 354 through which screw 356 is used to secure the implantable magnetic assembly 352 to bone fixture 246B. As can be seen in FIGS. 3 and 4B, the head of the screw 356 is larger than hole 354 and thus the screw positively retains implantable magnetic assembly 352 to bone fixture 246B. The portions of screw 356 that interface with the bone fixture 246B substantially correspond to an abutment screw of a percutaneous abutment for a percutaneous bone conduction device, thus permitting screw 356 to readily fit into an existing bone fixture used in a percutaneous bone conduction device. In an exemplary embodiment, screw 356 is configured so that the same tools and procedures that are used to install and/or remove an abutment screw from bone fixture 246B can be used to install and/or remove screw 356 from bone fixture 246B.

In an alternative embodiment, through hole 354 depicted in FIG. 3 for screw 354 may include a section that provides space for the head of the screw such that the top of the screw can sit flush with the top surface, below the top surface or only slightly proud of the top surface of arm structure 351. However, in other embodiments, the entire head of the screw 356 sits proud of the top surface of the arm structure, as shown in FIGS. 3 and 4B.

As may be seen in FIG. 3, arm structure 351 is contoured to the outer contours of bone fixture 246B. This contour, along with through hole 354, forms a bone fixture interface section that is contoured to the exposed section of the bone fixture 246B. In an exemplary embodiment, as may be seen in FIG. 3, the side of the head of screw 356 interfacing with arm structure 351 is contoured to the shape of the arm structure on the side facing away from the bone fixture.

It is noted that while the embodiment of FIG. 3 utilizes a bone fixture having a conical shaped portion that interfaces with arm structure 351, in other embodiments, different bone fixtures may be used that have a cylindrical, multilobular, hexagonal or other polygonal shaped interface. In some such embodiments, arm structure 351 is contoured to these shapes. It should be appreciated that any interface configuration may be implemented provided that the teachings herein and/or variations thereof may be practiced.

Arms 357A and 357B of structure 351 extend respectively from housings 353A and 353B to bone fixture 246B. In an exemplary embodiment, structure 351 is part of housings 353A and 353B. By way of example, the top portions of the housings (e.g., the portions facing the skin of the recipient) may be part of the same component as arm structure 351 (e.g., the top portions of the housings and arm structure 351 may form a monolithic structure). The component may be in the form of a titanium plate formed from a single sheet of titanium (e.g., via stamping, laser cutting, machine cutting, etc.). The remainder of the housings may be joined to this component after the magnets are positioned in the respective housings, thus hermetically sealing the magnets in the respective housings. Joining may be performed via, for example, laser welding or the like in embodiments where the reminder of the housings are also made of a metal, such as titanium, or via silicone adhesion in embodiments where the remainder of the housings are silicone, etc. It is noted that in some embodiments, the housings may be made of other metals/metal alloys, such as stainless steel. In some other embodiments, the housings may be made of polymers such as plastics. Any material that will permit the teachings herein and/or variations thereof to be practiced may be used in alternative embodiments.

In the embodiments of FIGS. 3-4B, arm structure 351 in general, and arms 357A and 357B in particular, are made from a titanium plate. The arms have a width that is substantially larger than a thickness of the arms, as may be seen. It is noted that in the illustrative embodiment, the main body of fixture 246B has a length that is about 5 mm, measured from the planar bottom surface 8 of flanges 6B to the end of distal region 1B and/or the top of the bone fixture and/or the top of screw 356 is about 0.4 to 1 mm about the top of the skull. Other embodiments may be practiced with components of the prostheses depicted herein and/or variations thereof having a different scale. Length of the arms (i.e., distance along the longitudinal axis of the arms) may vary depending on application of the implantable components, as will be further detailed below.

While the structure that holds housings 353A and 353B (and thus the magnets contained therein) at a fixed spatial orientation relative to one another has been depicted as having arms 357A and 357B, other structures may be utilized to so retain the housings at a desired relative orientation. By way of example, in one embodiment, a circular plate that extends outward from bone fixture 246B, having a perimeter that is concentric with longitudinal axis 401 of the bone fixture. Such a configuration may be used to so hold three or four or five or six or more separate housings containing respective magnets, where the respective housings may or may not be arrayed with equal spacing about the longitudinal axis 401 of the bone fixture. Any device, system or method that may bridge the distance between the housings and the bone fixture and hold the housings in place as detailed herein and variations thereof can be used in at least some embodiments.

FIGS. 3-4B show that the entire outer periphery of the respective housings 353A and 353B, and thus the respective magnet 355A and 355B, are located within respective areas bounded by legs of an angle (angle 402 with respect to housing 353A, as may be see in FIG. 4A) about a longitudinal axis of the bone fixture that is less than or equal to about 80 degrees, and the entire housing is offset from the longitudinal axis. Some embodiments may be such that the entire outer periphery of the respective housings 353A and 353B, and thus the respective magnet 355A and 355B, are located within respective areas bounded by legs of an angle about a longitudinal axis of the bone fixture that is less than or equal to about 180 degrees, about 160 degrees, about 145 degrees, about 135 degrees, about 125 degrees, about 115 degrees, about 100 degrees, about 90 degrees, about 80 degrees, about 70 degrees, about 60 degrees, about 50 degrees, about 45 degrees, about 40 degrees, about 35 degrees, about 30 degrees, about 25 degrees, and/or about 20 degrees.

Referring again to FIG. 3, it can be seen that housings 353A and 353B are located above the surface of bone 136. That is, in the embodiment of FIG. 3, there is no bone excavation, and thus the housings are not partially or fully submerged beneath the surface of bone 136. In at least some embodiments of this configuration, provided that any resistance resulting from any compression of the arm structure 351 between screw 356 and bone fixture 246B may be overcome (such as may be the case if screw 356 is only partially tightened), the implantable magnet assembly 352 may be turned at least partially (including fully, i.e., 360 degrees) about longitudinal axis 401 of bone fixture 246B. Such embodiments may have utility in that during implantation of implantable magnetic assembly 352, a surgeon or the like can adjust the orientation of the assembly about bone fixture 246B. Such may be done to position the assembly 352 at a location where the assembly adequately and/or best conforms to the shape of skull bone 136 while still retaining the assembly to the bone fixture with screw 356. With respect to the embodiments depicted in FIGS. 3-4B, such location may be a location where the skull is relatively flat along the longitudinal direction of the implantable magnetic assembly 352. As will be detailed below, in some embodiments, arm structure 351 is curved. Accordingly, such turning may position assembly 352 at a location where the curvature of the skull bone 136 adequately and/or best conforms to the curvature of the assembly.

In other embodiments, housings 353A and 353B are partially submerged beneath the surface of bone 136, which may be a result of bone excavation at the portions of the skull proximate to the housings. In other embodiments, housings 353A and 353B are submerged beneath the surface of bone 136 (i.e., the top of the housings are at or below an extrapolated surface of bone 136, which likewise may be a result of bone excavation at the portions of the skull proximate to the housings. The bone excavations may be such that the implantable magnetic assembly may be at least partially turned about longitudinal axis 401 of bone fixture 246B.

Embodiments of arm structure 351 that may be utilized to achieve the aforementioned partially and fully submerged housings is described below.

As may be seen in FIGS. 3-4B, magnets 355A and 355B are offset from bone fixture 246B with respect to spatial locations around longitudinal axis 401 of the bone fixture. In this regard, FIG. 4A shows the view of implantable magnetic assembly 352, when viewed from the top, around longitudinal axis 401 of the bone fixture. FIG. 4A shows that magnets 355A and 355B are positioned such that at least one plane lying on the longitudinal axis 401 of the bone fixture does not intersect a magnet.

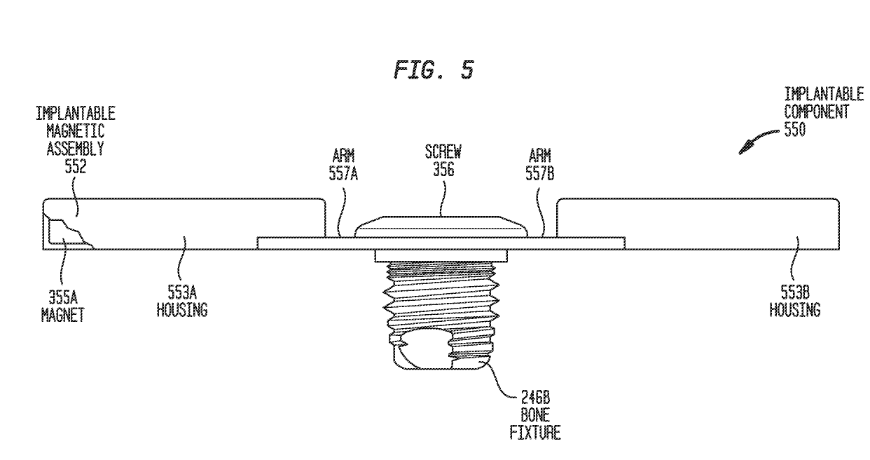

FIG. 5 depicts an alternate embodiment of an implantable component 550 usable with the bone conduction device 100. As may be seen, implantable magnet assembly 552 includes two separate housings 553A and 553B connected to bone fixture 246B via arms 557A and 557B, respectively. Arms 557A and 5578 interface with the respective housings 553A and 553B at the bottoms of the housings as opposed to the tops of the housings as in the embodiment of FIGS. 3-4B. It is noted that in alternate embodiments, the arms may interface with the housings at a location in between the top and the bottom (e.g., the middle) of the housings, and one or more housings may have an interface that is located differently than that of the other housing(s). Any location of interface of the arms with the housings may be used in some embodiments provided that the teachings and variations thereof may be implemented.

In some embodiments, the arms of the implantable magnet assemblies are configured to flex in a plane lying on the longitudinal axis 401 of bone fixture 246B (i.e., up and down with respect to the view of FIG. 5). Such may permit the housings to better conform to the surface of the skull (which may be curved and/or may have irregular surface altitudes) and/or the excavation of the skull (which likewise may have bottoms that have surfaces that are curved and/or irregular surface altitudes). In some embodiments, the arms are configured to flex such that elastic and/or plastic deformation occurs. Plastic deformation may be utilized to hold the housings in a given position without the need for external force applied to the implantable magnet assembly after the flexure. Conversely, in some embodiments, the arms are rigid. In some embodiments, one more arms are flexible and one or more arms are rigid.

It is also noted that in some embodiments, the arms may be twisted so that the housings may be rotated relative to one another (i.e., rotated about the longitudinal axis of the implantable magnetic assembly). In some embodiments, the arms are configured to be twisted such that elastic and/or plastic deformation occurs.

In an exemplary embodiment, a surgeon or the like flexes one or more arms to position the housings at a desired orientation relative to one another so that the housings conform to the bone 136 as desired. In an exemplary embodiment, the implantable magnet assembly is configured such that the arms are hand-malleable. That is, the arms may be plastically deformed as a result of force applied by hand (without mechanical advantage) by a surgeon or the like having physical characteristics of the thirtieth percentile United States citizen female of age between 18 and 50 years at the time of filing of this application. In an exemplary embodiment, the implantable magnet assembly is configured such that the arms are hand-rigid. That is, the arms may not be plastically deformed as a result of force applied by hand (without mechanical advantage) by a surgeon or the like having physical characteristics of the seventieth percentile United States citizen male of age between 18 and 50 years at the time of this application filing. These deformations may correspond to deformations of the arms in the plane lying on the longitudinal axis of the bone fixture and/or may correspond to twisting about the longitudinal axis of the implantable magnetic assembly.

It is noted that in some embodiments, the implantable magnetic assembly may have a shape that is preformed (e.g., precurved) to better conform to a skull.

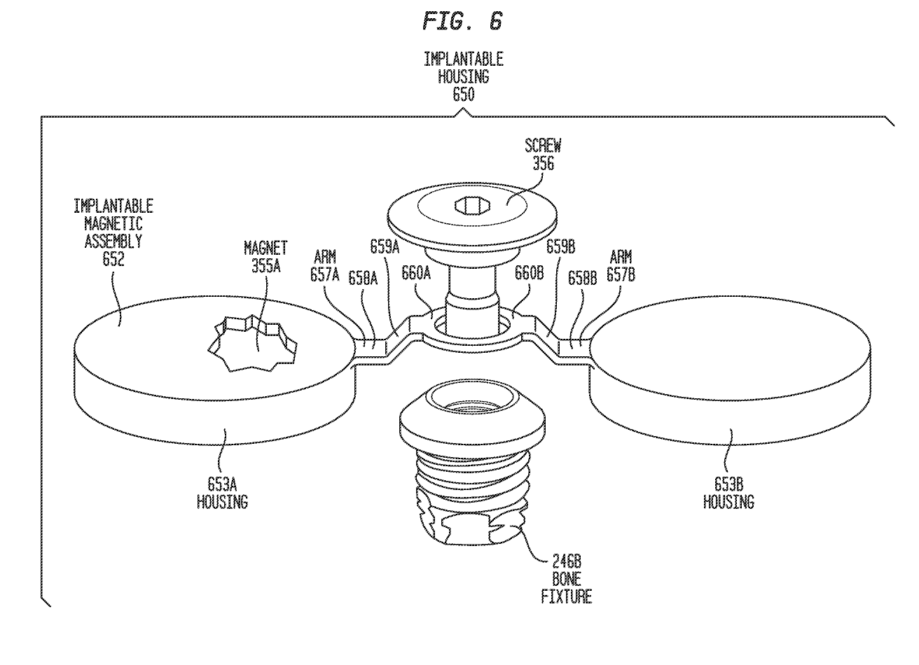

FIG. 6 depicts another alternate embodiment of an implantable component 650 usable with the bone conduction device 100. Implantable magnet assembly 652 includes two separate housings 653A and 653B connected to bone fixture 246B via arms 657A and 657B, respectively. Arms 657A and 657B interface with the respective housings 653A and 653B at the tops of the housings as with the embodiment of FIGS. 3-4B. In alternate embodiments, the arms may interface at other locations as detailed herein.

FIG. 6 depicts arms having compound extension directions. Particularly, arm 657A has a first section 658A that extends in a direction normal to the longitudinal axis 401, a second section 659A that extends in a direction not normal to the longitudinal axis 401, and a third section 630A that extends in a direction normal to the longitudinal axis 401. Likewise, arm 657B has a first section 658B that extends in a direction normal to the longitudinal axis 401, a second section 659B that extends in a direction not normal to the longitudinal axis 401, and a third section 630B that extends in a direction normal to the longitudinal axis 401.

As may be seen, arms 657A and 657B have a thickness that is about the same as arms 357A and 357B of implantable magnet assembly 352, but have a width that is less than the width of arms 357A, 357B of implantable magnet assembly 352. In an exemplary embodiment, this enables arms 657 to be flexed more easily (i.e., the arms have less resistance to flexure), as compared to the arms of the implantable magnet assembly 352 when the material properties of the arms are the same in the both embodiments, because there is less material to be flexed. In some embodiments, arms of the configuration of the implantable magnet assembly 352 are not flexible while arms of the configuration of the implantable magnetic assembly 652 are flexible owing to the fact that the widths of the arms are different while the material characteristics of the arms are the same.

FIGS. 3-6 depict housings that have a circular perimeter and respective magnets that also have a circular perimeter. In other embodiments, the housings and/or magnets may have perimeters of different shapes (e.g., rectangular, oval, etc.). The embodiments depicted in FIGS. 3-6 have housings and magnets having a perimeter that is substantially the same, both in shape and in size. In alternative embodiments, the perimeter of the magnets and housings may be different, either in shape and/or in size. Moreover, in other embodiments, the shapes and/or sizes of the perimeters of the respective magnets of a given implantable magnetic assembly may be different. In other embodiments, the dimensions of the perimeter of the respective housings of a given implantable magnetic assembly may be different. Housings and/or magnets of any shape and/or size may be used in some embodiments providing that the teachings detailed herein and variations thereof may be implemented.

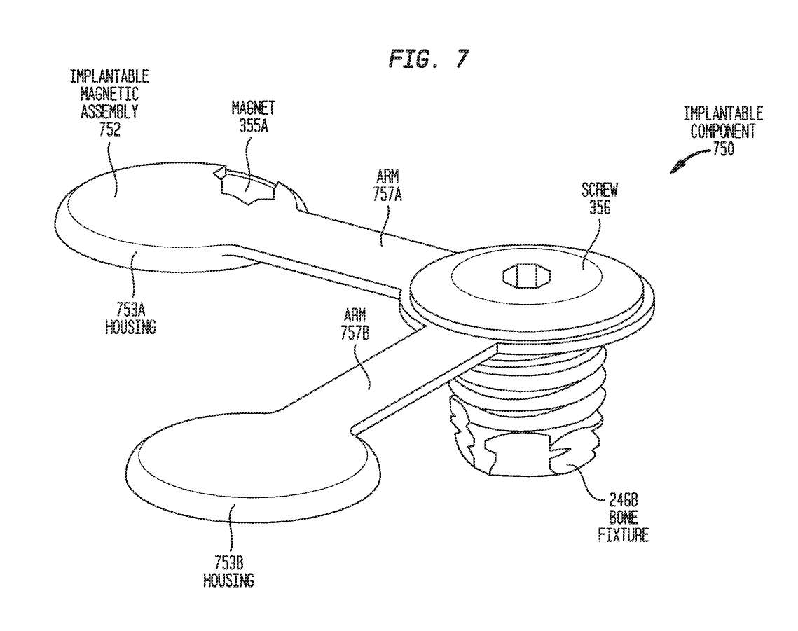

Embodiments of FIGS. 3-6 have housings that are located in radially opposing positions relative to the bone fixture. In an alternate embodiment, as seen in FIG. 7, the housings may be arranged in a different manner. FIG. 7 depicts an implantable component 750 usable with the bone conduction device 100 including an implantable magnetic assembly 752. Implantable magnetic assembly 752 has a housing 753A and a housing 753B which are connected to the bone fixture 246B via arms 757A and 757B, respectively. The collective entire outer peripheries of the respective housings 753A and 753B, and thus the respective magnets, are located within respective areas bounded by legs of an angle about the longitudinal axis of the bone fixture 246B that is less than or equal to about 80 degrees, and the entirety of both housings are offset from the longitudinal axis. Some embodiments may be such that the collective entire outer peripheries of the respective housings 753A and 753B, and thus the respective magnets, are located within respective areas bounded by legs of an angle about a longitudinal axis of the bone fixture that is less than or equal to about 180 degrees, about 160 degrees, about 145 degrees, about 135 degrees, about 125 degrees, about 115 degrees, about 100 degrees, about 90 degrees, about 80 degrees, about 70 degrees, about 60 degrees, about 50 degrees, about 45 degrees, about 40 degrees, and/or about 35 degrees.

FIG. 7 also depicts that housings may have different general configurations in different embodiments. In this regard, the housings of FIGS. 3-6 are generally cylindrical, while the housings of FIG. 7 are saucer shaped. Some embodiments of the implantable magnetic components may have housings of different general configurations.

Embodiments utilizing two or more separate magnets, such as those of FIGS. 3-7, may have utility in that a recipient may alternate a position of the external component of the bone conduction device. Such may be done for comfort reasons and/or to reduce the likelihood of and/or effects of necrosis. In some embodiments, the separate magnets have different strengths such that when the external component is located over one magnet, the magnetic coupling force is greater than that when the external component is located over another magnet. A recipient can position the external component between the two magnets to adjust the holding force. Such may have utility if the recipient is engaging in sports or other activities that result in higher G-forces experienced by the external component (e.g., running) needing a higher holding force that may be less comfortable than the lower holding force, which is used for normal use.

In some embodiments, the housings and/or the arms of the implantable magnetic assembly may be over molded with silicon or the like to provide a greater pressure distribution, thus rendering use of the bone conduction device more comfortable than would be the case in the absence of the over molding.

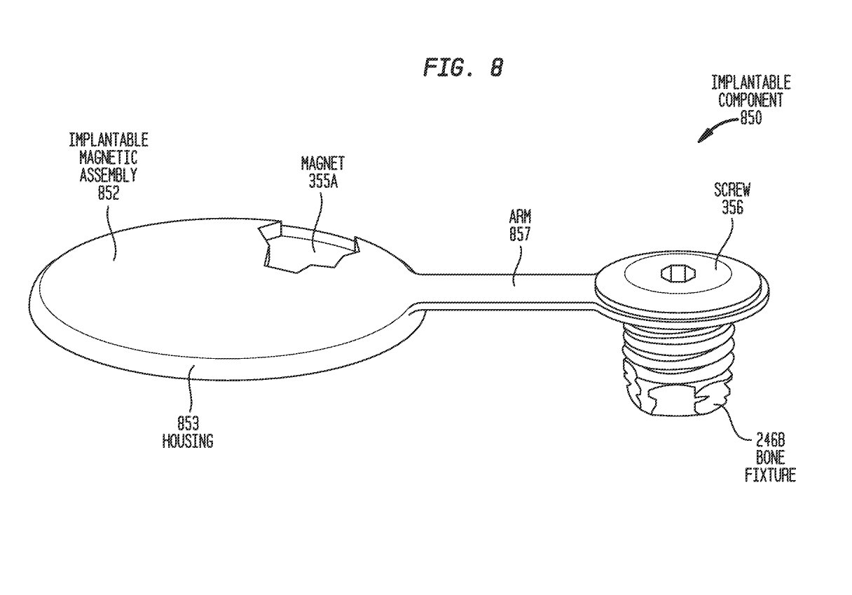

The features detailed above with respect to the embodiment of FIG. 7 are also applicable to some embodiments that utilize a single magnet/single housing, such as the implantable component 850 of FIG. 8. Implantable magnetic assembly 852 of implantable component 850 includes a single housing 853 that houses a single magnet 355A. Housing 853 is connected to bone fixture 246B via arm 857.

Some embodiments of FIGS. 7 and 8 enable the external component to be located above bone away from the bone fixture. This because the magnet(s) are offset from the bone fixture and are located to one side of the bone fixture. In some embodiments, this enables implantation of the bone fixture into the skull at a location closer to the ear canal that that would be the case with embodiments where the magnet(s) are located about the bone fixture. This because the external component may be located away from the implant site, whereas the outer anatomy of a human above the bone fixture may not be conducive/as conducive towards maintenance of a magnetic coupling between the external component and the implantable component sufficient to permit effective bone conduction to evoke a hearing percept.

As noted above, magnets of different sizes, shapes and configurations may be used in some embodiments. In this regard, FIG. 8 depicts a larger housing than either of the housings of the embodiment of FIG. 7. This because housing 853 of FIG. 8 houses a larger magnet than the individual magnets of FIG. 7 so as to compensate for the fact that there is only one magnet used in the embodiment of FIG. 8. That is, the embodiment of FIG. 8 utilizes a larger magnet to compensate for the lack of multiple magnets so as to establish a sufficiently strong magnetic coupling between the implantable component and the external component.

From FIGS. 3-8, it can be seen that embodiments of the implantable component utilize a single bone fixture to secure the implantable magnetic assembly to bone. The bone fixtures are configured to be connected to a percutaneous abutment for use with percutaneous bone conduction devices. Accordingly, the fixation systems used with embodiments herein and/or variations thereof utilize a single implant and have stability characteristics utilizing that single implant that are substantially similar to (including the same as) those of bone fixtures of percutaneous bone conduction devices.

The bone fixture is configured to osseointegrate to the bone, while, in at least some embodiments, the implantable magnetic assemblies are configured to resist osseointegration to the bone. This enables the implantable magnetic assemblies to be more easily explanted relative to implantable magnetic assemblies that osseointegrate to the bone. Such may have utility in the case of removal of the implantable magnetic assemblies prior to an MRI examination, etc. Further along these lines, because the implantable magnetic assembly may be explanted while keeping the bone fixture implanted in the bone, the bone may experience little to no trauma, and thus there is little to no healing period after the implantable magnetic assembly is attached/reattached to the bone fixture that may take place prior to use of the implantable component for bone conduction.

Some portions of and/or all of the implantable magnetic assembly may be coated in silicone and/or other polymeric materials to inhibit/prevent osseointegration of the assembly to the bone. Some portions of and/or all of the implantable magnetic assembly may be polished, and surfaces mating with bone may be polished titanium, so as to inhibit/prevent osseointegration of the assembly to the bone.

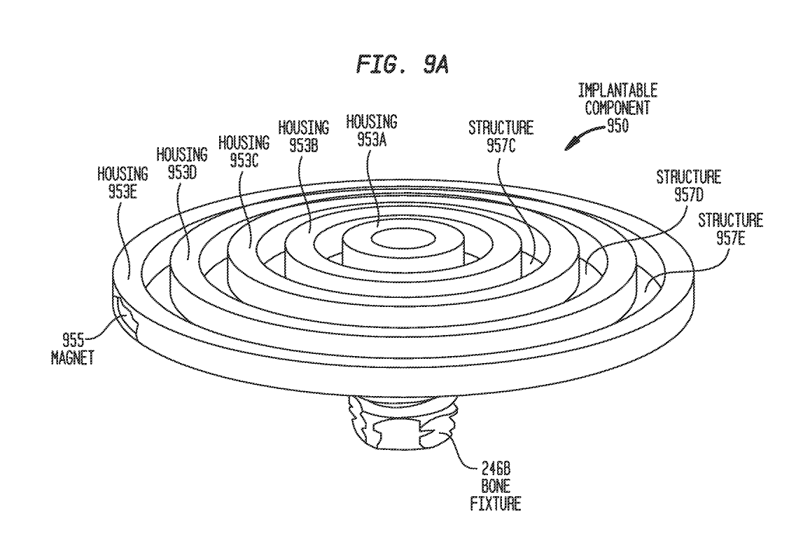

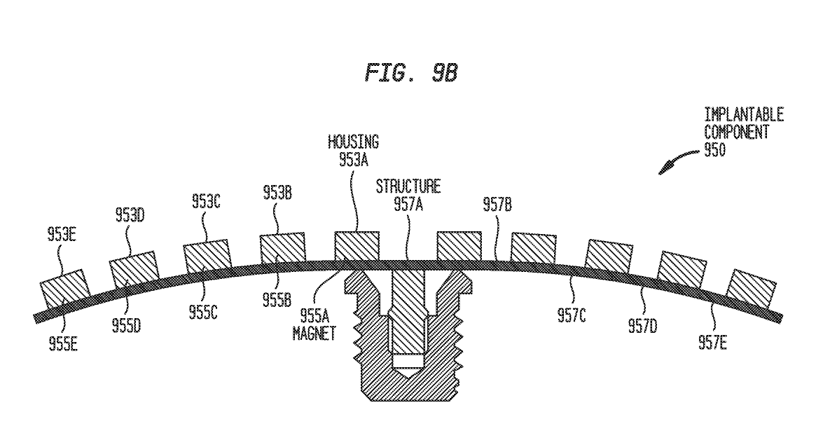

FIGS. 9A and 9B depict an alternate embodiment of an implantable component 950 usable in the bone conduction device 100. Implantable component 950 includes an implantable magnet assembly comprising five annular housings 953A, 953B, 953C, 953D and 953E which hermetically house respective annular magnets 955A, 955B, 955C, 955D and 955E. A support structure in the form of a plate having bridge components 957A; 957B, 957C, 957D and 957E between the magnets supports the annular magnets as may be seen. In alternate embodiments, the support structure may be a mesh and/or may be a frame. Any support structure that will permit the embodiment of FIGS. 9A-9B to be practiced may be used in some embodiments.

The support structure may have some and or all of the characteristics of the arm structures detailed above. In this regard, the support structure may be flexible or rigid. In an exemplary embodiment, the support structure has a curved shape, as seen in FIG. 9B, that generally conforms to the curved shape of a skull bone.

The embodiment of FIGS. 9A-9B may have utility in that a shock force applied thorough the skin of the recipient in the vertical direction onto the implantable component 950 may be dissipated horizontally out to the sides of the implant. Such may result from the flexibility of the support structure. In some embodiments, at least a portion of some of the housings may be at least partially submerged beneath the surface of the bone.

While various embodiments of the present disclosure have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present disclosure should not be limited by any of the above-described exemplary embodiments, but should be defined only in accordance with the following claims and their equivalents.

What is claimed is:

1. An implantable component of a prosthesis, comprising:
a bone fixture; and
one or more magnets disposed in a housing coupled to the bone fixture via a structure extending between the housing and bone fixture.

2. The implantable component of claim 1, wherein:
the one or more magnets are offset from fixture.

3. The implantable component of claim 1, wherein:
the structure is an elongate member.

4. The implantable component of claim 1, wherein:
the structure has a thickness and a width, wherein the width is substantially larger than the thickness.

5. The implantable component of claim 1, wherein:
the structure is a bridge between the housing and the bone fixture.

6. The implantable component of claim 1, wherein:
the structure is located between the housing and the bone fixture only within an arc about a longitudinal axis of the bone fixture that is less than or equal to about 180 degrees.

7. The implantable component of claim 6, wherein:
the structure is located between the housing and the bone fixture within an angle about a longitudinal axis of the bone fixture that is less than or equal to about 100 degrees.

8. The implantable component of claim 1, further comprising:
at least two magnets, the at least two magnets being disposed in respective housings coupled to the bone fixture via respective structures that extend from the respective housings to the bone fixture.

9. The implantable component of claim 8, wherein:
the at least two magnets are located at respective substantially exactly opposite locations about a longitudinal axis of the bone fixture.

10. The implantable component of claim 7, wherein:
the at least two magnets are located such that the two magnets fall within an arc about the longitudinal axis of the bone fixture that is less than about 180 degrees.

11. The implantable component of claim 1, wherein:
at least a portion of the structure extends from the housing towards the bone fixture in a compound direction.

12. The implantable component of claim 1, wherein:
at least a portion of the structure is substantially hand-rigid.

13. The implantable component of claim 1, wherein:
at least a portion of the structure is substantially hand-malleable.

14. The implantable component of claim 1, wherein:
the implantable component comprises a passive transcutaneous bone conduction device.

15. An implantable component of a prosthesis, comprising:
a bone fixture; and
at least one magnet coupled to and laterally offset from a longitudinal axis of the bone fixture, wherein boundaries of the at least one magnet are located within an angle about a longitudinal axis of the bone fixture that is less than 360 degrees.

16. The implantable component of claim 15, wherein the angle is less than 90 degrees.

17. The implantable component of claim 15, further comprising:
at least one structure extending between the magnet and bone fixture, wherein the structure is an elongate member.

18. The implantable component of claim 17, wherein the structure has a thickness and a width, wherein the width is substantially larger than the thickness.

19. The implantable component of claim 17, wherein the structure is a bridge between the housing and the bone fixture.

20. The implantable component of claim 15, wherein boundaries of the structure are located between the housing and the bone fixture within an angle about a longitudinal axis of the bone fixture that is less than or equal to about 180 degrees.

21. An implantable component of a hearing prosthesis, comprising:
at least one magnet; and
a bone fixture, wherein
the at least one magnet is disposed in a housing, and
the housing is flexibly coupled to the bone fixture.

22. The implantable component of claim 21, wherein:
the magnet is offset from the fixture.

23. The implantable component of claim 21, wherein:
the magnet surrounds the fixture.

24. The implantable component of claim 21, wherein:
an outer periphery of the magnet and an outer periphery of the bone fixture are concentric.

25. The implantable component of claim 21, wherein:
an outer periphery of the magnet and an outer periphery of the bone fixture are non-concentric.

26. The implantable component of claim 21, further comprising a flexible frame that flexibly couples the housing to the bone fixture.

27. The implantable component of claim 21, wherein:
the housing is flexibly coupled to the bone fixture via a flexible structure.

28. The implantable component of claim 23, wherein:
the flexible structure is an elongate member.

29. The implantable component of claim 21, further comprising a flexible plate that flexibly couples the housing to the bone fixture.

30. The implantable component of claim 21, further comprising a plurality of magnets that are concentric with one another and the bone fixture.
